(19) United States
(12) Patent Application Publication
(10) Pub. No.: US 2009/0237611 A1
(43) Pub. Date: Sep. 24, 2009

(54) OPTICAL APPARATUS

(76) Inventors: Glyn Walsh, Stirlingshire (GB); Jonathan Bannister, Fife (GB)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 12/302,689

(22) PCT Filed: Jun. 1, 2007
(86) PCT No.: PCT/GB2007/002026

§ 371 Date: Nov. 26, 2008

(30) Foreign Application Priority Data
Jun. 1, 2006 (GB) 0610914.4

(51) Int. Cl. G02B 27/02

(52) U.S. Cl. 351/158; 359/835

(57) ABSTRACT

The present invention relates to optical apparatus. The optical apparatus (10) comprises: a support configured for location and use of the optical apparatus near an eye of a user of the optical apparatus; and an optical device (12) supported by the support such that, in use, the optical device (12) is within a visual field of the eye of the user, the optical device being configured to reverse a field of view of the user's eye through the optical device (12) laterally with respect to the user's eyes.

### CROSS-REFERENCE TO RELATED APPLICATIONS

This application is a §371 of International Application No. PCT/GB2007/002026, with an international filing date of Jun. 1, 2007 (WO 2007/138330 A1, published Dec. 6, 2007), which claims priority of British Patent Application No. 0610914.4, filed Jun. 1, 2006, the subject matter of which is incorporated by reference.

### FIELD OF THE INVENTION

The present invention relates to optical apparatus and in particular but not exclusively to optical apparatus suitable for treatment, investigation and diagnosis of pain, for stroke rehabilitation, for brain injury rehabilitation or for treatment of physical and visual dysfunction or as an experimental apparatus.

### BACKGROUND TO THE INVENTION

The above mentioned medical conditions can be treated by means of what is termed a mirror box. A mirror box consists of two separate, side-by-side compartments and a mirror arrangement. A user either inserts his or her left arm in the left compartment or his or her right arm in the right compartment. The compartment into which the arm is inserted is covered in order to hide the inserted limb from view. The mirror arrangement inside the mirror box inverts the image of the inserted limb so that it appears to the user to be present in the other compartment and thus appears to be his or her other limb. For example, if the user inserts his or her left arm he or she sees a reversed view of his or her left arm such that it appears to be his or her right arm. This optically created illusion of the presence of the right arm tricks the user's brain into believing that movement of the left arm is actually the right arm moving. As a result, it is understood that the brain undergoes re-mapping that could improve the above mentioned medical conditions stated in the field of the invention section.

The mirror box has disadvantages. More specifically, the mirror box can be impractical for frequent use and can be unsuited to use with the leg.

Recently much activity has been seen in the development of drug treatments for PLP. However, drug treatments can produce undesirable side effects.

Conversely in dyslexia and similar syndromes visual perceptual reversals occur and the potential in this has yet to be investigated.

Other asymmetric neurological conditions, such as stroke, visual neglect syndrome and complex regional pain syndrome, may benefit from mirror box therapy. Furthermore, other ophthalmic conditions, such as cyclotorsion of the eye or diplopia, may be diagnosed using image reversal such as is provided by the mirror-box. In addition, rehabilitation of patients following limb injury and surgery, including the rehabilitation of athletes, may also benefit from optical illusions created by the mirror box.

### STATEMENT OF INVENTION

The present invention has been devised in the light of the above mentioned problems of known approaches to treatment of the above mentioned medical conditions.

It is therefore an aim of the present invention to provide for an apparatus suitable for treatment of the above mentioned medical conditions.

More specifically, it is an aim of the present invention to provide an optical apparatus for treatment of the above mentioned medical conditions.

According to a first aspect of the present invention there is provided optical apparatus comprising: a support configured for location and use of the optical apparatus near an eye of a user of the optical apparatus; and an optical device supported by the support such that, in use, the optical device is within a visual field of the eye of the user, the optical device being configured to reverse a field of view of the user's eye through the optical device laterally with respect to the user's eyes.

As an example of the use of the device in the treatment of Phantom Limb Pain (PLP), a user locates the support of the optical apparatus in front of one of his eyes and views his remaining limb, e.g. his arm, through the optical device. The optical device reverses the field of view of the user's eye laterally with respect to his eyes. Reversal of the field of view of the user's eye laterally with respect to his or her eyes means that the field of view is reflected about a sagittal plane. Thus, for example if the user views his left arm through the optical device it appears to him that his right, amputated arm is present.

An advantage of the optical apparatus is that the optical apparatus is more portable and less obstructive than the mirror box, thereby allowing for greater freedom of movement by a user. The optical apparatus also provides for a closer approximation to a normal visual environment for a user. This provides for ease of storage and transportation and for use in a home environment. In addition, the optical apparatus provides for greater ease of use with a lower limb than the mirror box.

More specifically, the optical device may comprise an optical component that defines a reflecting plane about which the field of view is reflected.

More specifically, the optical device may be configured such that the reflecting plane defined by the optical component is substantially in the sagittal plane.

Alternatively or in addition, optical apparatus may be configured such that the reflecting plane faces towards one of a temporal side and a nasal side of the user's visual field.

Alternatively or in addition, the optical device may comprise a mirror.

Alternatively or in addition, the optical device may comprise at least one prism. For example, the optical device may comprise a pair of prisms.

More specifically, the prism may be configured to provide for total internal reflection. The prism may be triangular.

Alternatively or in addition, the prism may be truncated in form, e.g. a Dove prism.

Alternatively or in addition the optical device may comprise at least one Fresnel-type prism. For example, the optical device may comprise a pair of Fresnel-type prisms.

Alternatively or in addition, the optical device may comprise a pair of astigmatic lenses.

Alternatively or in addition, the optical device may be configured to provide, in use, a field of view that extends in the meridional plane at least one of: above the eye and below the eye. Extension of the field of view in the meridional plane below the eye can provide for an adequate view of a lower limb of a user.

More specifically, the optical device may be truncated distally and towards an eye of a user. Thus, a portion of the optical device outwith a field of view of the optical device may be absent. This can provide for a reduction in weight of the optical apparatus.

Alternatively or in addition, when the optical device comprises a prism, the optical device may further comprise at least one lens.

More specifically, the optical device may comprise one positively powered lens. Thus, the positively powered lens may magnify an object viewed by the user.

More specifically, the positively powered lens may be disposed in relation to the prism such that, in use, the positively powered lens is one of: closer to the viewer's eye than the prism; and further away from the viewer's eye than the prism. An extent of magnification of the viewed object depends on a distance between the user's eye and the positively powered lens.

Alternatively or in addition, the optical device may comprise one negatively powered lens. Thus, the negatively powered lens may minify an object viewed by the user.

More specifically, the negatively powered lens may be disposed in relation to the prism such that, in use, the negatively powered lens is one of: closer to the viewer's eye than the prism; and further away from the viewer's eye than the prism. An extent of minification of the viewed object depends on a distance between the user's eye and the negatively powered lens.

Alternatively or in addition, the optical device may comprise at least one astigmatic lens. The astigmatic lens may be disposed in the optical apparatus such that, in use, an image of an object viewed by a user may be meridionally distorted.

More specifically, where the optical device comprises a plurality of astigmatic lenses, astigmatic axes of the astigmatic lenses may be parallel. Also, differences of focal lengths of the lenses in each meridian may be the same. Thus, meridians of such an arrangement may be in optimal focus.

Alternatively or in addition, when the optical device comprises a prism, the optical device may further comprise a pair of lenses.

More specifically, the pair of lenses may consist of a positively powered lens and a negatively powered lens.

More specifically, the optical apparatus may be configured such that, in use, the positively powered lens is disposed further away from a user's eye than the prism and the negatively powered lens is disposed closer to the user's eye than the prism. Such a configuration may provide for magnification or, less readily, minification of a viewed object.

An extent of magnification of a viewed object may be determined by a ratio of focal lengths of the positively and negatively powered lenses. Alternatively, an extent of minification of a viewed object may be determined by a ratio of focal lengths of the positively and negatively powered lenses and where the focal length of the negatively powered lens is greater than the focal length of the positively powered lens.

Alternatively, the optical apparatus may be configured such that, in use, the negatively powered lens is disposed further away from a user's eye than the prism and the positively powered lens is disposed closer to the user's eye than the prism. Such a configuration may provide for minification or, less readily, magnification of a viewed object.

An extent of minification of a viewed object may be determined by a ratio of focal lengths of the positively and negatively powered lenses. Alternatively, an extent of magnification of a viewed object may be determined by a ratio of focal lengths of the positively and negatively powered lenses and where the focal length of the negatively powered lens is greater than the focal length of the positively powered lens.

Alternatively or in addition, the optical apparatus may be configured for viewing parts of a user's body.

More specifically, a distance between the pair of lenses may be greater than a difference of the focal lengths of the lenses.

Alternatively or in addition, the optical apparatus may be configured for viewing objects further away from the optical apparatus than parts of a user's body.

More specifically, a distance between the pair of lenses may substantially equal to a difference of the focal lengths of the lenses.

Alternatively or in addition, the optical device may comprise a pair of Fresnel-type astigmatic lenses.

Alternatively, the optical device may comprise a pair of cylindrical lenses spaced apart from each other in a direction away from the user's face when the optical apparatus is in use.

More specifically, the lower optically powered surfaces of the pair of cylindrical lenses may face each other.

Alternatively or in addition, respective focal lengths of the astigmatic lenses may be substantially the same. This can provide for a magnification factor of one of an object viewed with the optical apparatus.

Alternatively, respective focal lengths of the astigmatic lenses may be unequal. Thus, where the focal length of the lens closer to a face of the user is less than the focal length of the other lens a lateral field of view through the optical device is decreased with resultant horizontal magnification of less than unity. Conversely, where the focal length of the lens closer to the face of the user is greater than the focal length of the other lens, the lateral field of view through the optical device is increased with resultant horizontal magnification of greater than unity.

Alternatively or in addition the lenses may comprise a curved surface, such as a hyperbola. Such a curved surface provides for optimisation for optical performance.

The optical apparatus may further comprise another optical device which is supported by the support such that the two optical devices are spaced apart from each other, the other optical device being configured to reverse a field of view of a user's other eye when in use.

More specifically, the optical apparatus may be configured and the two optical devices spaced apart from each other such that when the optical apparatus is located and used near the eyes of the user, a respective one of the two optical devices is within a visual field of a respective one of the user's two eyes. Thus, the optical apparatus can be used to reverse the field of view of both eyes of the user simultaneously.

Alternatively or in addition, an orientation of one of the two optical devices in relation to the support may be fixed and an orientation of the other of the two optical devices in relation to the support may be changeable.

Alternatively or in addition, the two optical devices may be oriented such that, in use, their respective fields of view are directed to substantially the same object.

In a form of the present invention, the optical apparatus may be configured to be worn by a user of the optical apparatus.

More specifically, the, optical apparatus may be configured to be worn on the head of a user of the optical apparatus. Thus, the optical apparatus may form part of a pair of spectacles.

Alternatively or in addition, the support may be configured for attachment of the optical apparatus to wearable apparatus configured to be worn by the user.

More specifically, the support may be configured for attachment of the optical apparatus to wearable apparatus configured to be worn on the head of the user, such as a pair of spectacles.

Alternatively or in addition, the support may be configured for releasable attachment of the optical apparatus to the wearable apparatus.

More specifically, the support may comprise a clip configured to engage the wearable apparatus.

More specifically, the support may comprise a biasing device, such as a spring, that is operative to bias the clip and provide for tight engagement of the clip and the wearable apparatus.

In another form of the invention, the optical apparatus may be configured to be held by a user of the optical apparatus. Thus, the support may comprise at least one gripping surface configured to be gripped by the user. Thus, the user can hold the optical apparatus with the gripping surface and bring the optical apparatus near to one of his eyes for use of the apparatus with that eye.

Alternatively or in addition, the optical apparatus may have a weight of less than about 50 grams.

More specifically, the optical apparatus may have a weight of less than about 25 grams.

Alternatively or in addition, optical apparatus may comprise a restricting member configured to restrict the field of view of the user's eye through the optical device. Thus, the field of view can be tailored to view a limb of the user, e.g. an arm or leg, and less of the environment around the limb.

More specifically, the restricting member may define the field of view of the user's eye through the optical device.

Alternatively or in addition, the restricting member may be configured to extend away from the user's face when the optical apparatus is in use.

More specifically, the restricting member may define a space extending away from the user's face when the optical apparatus is in use. Thus, the restricting member may form a tunnel through which the user looks with his eye when the optical apparatus is in use. The restricting member may, for example, define a tunnel of rectangular cross-section.

Alternatively or in addition, the restricting member may be attached to the support.

More specifically, the restricting member may be integrally formed with the support.

Alternatively or in addition, the optical apparatus may be configured to vary a centration distance. Variation of centration distance provides for use of the optical apparatus with different users, such different users having different eye spacings.

More specifically, the optical device may be movable laterally on the optical apparatus.

Alternatively or in addition, the optical device may be rotatable in relation to the optical apparatus. Thus, the optical device may be moved laterally.

More specifically, the optical device may be a prism that is inherently decentred, such as a Dove prism.

Alternatively or in addition, where the optical device is rotatable, the optical apparatus may comprise spaced apart indications which cooperate with an indicator that moves with the optical device to indicate an extent of rotation of the optical device.

Alternatively or in addition, the optical apparatus may comprise an inclination indication device operative to indicate a level of the optical apparatus with respect to the ground, such as by reference to the gravitation field of the earth.

More specifically, the inclination indication device may be operative to indicate when the optical apparatus is substantially level with respect to the ground.

More specifically, the inclination indication device may comprise a spirit level.

According to a second aspect of the present invention there is provided a pair of spectacles comprising optical apparatus according to the first aspect of the present invention.

More specifically, the pair of spectacles may comprise a first lens apparatus, which comprises the optical apparatus, and a second lens apparatus configured to obstruct a field of view of one of the user's eyes through the second lens apparatus.

More specifically, the second lens apparatus may comprise one of an opaque member configured to substantially block the passage of light therethrough and a translucent member configured to reduce the passage of light.

Alternatively or in addition, the pair of spectacles may be configured such that the optical apparatus is operative with either of both eyes of the user.

More specifically, the pair of spectacles may be configured such that they are wearable one way up or turned upside down and wearable a second way up. Thus, when worn the first way up the optical device can be used with one of the left and right eye of the user and when worn the second way up the optical device can be used with the other of the left and right eye of the user.

More specifically, the first and second lens apparatus may be spaced apart from each other and connected by a bridge, the bridge having at least one resilient member provided on the bridge such that when the spectacles are worn either way up the at least one resilient member is interposed between the nose of the user and the rest of the bridge.

Alternatively or in addition, the pair of spectacles may be configured such that the field of view of the user's eye through the optical device of the optical apparatus may be changed.

More specifically, the pair of spectacles may be configured such that the field of view may be moved laterally with respect to the user's eyes.

More specifically, the optical device may be moveable in relation to the pair of spectacles.

More specifically, the optical device may be rotatable in relation to the pair of spectacles.

In one form, the optical device may be movable such that a lateral direction of the movable device may be changed. Thus, the optical device may be rotatable about the coronal plane. For example, where the optical device is a prism, a direction of a face of the prism may be changed to change an orientation of a plane of reflection of the prism such that the plane of reflection can be made substantially in the sagittal plane. This feature can be used to provide an appropriate field of view when the pair of spectacles is used a first way up and when the pair of spectacles is turned upside down and used a second way up.

In a second form, the optical device may be rotatable within a plane that is parallel to a plane generally defined by the user's face when the pair of spectacle is in use. Thus, the optical device may be rotatable about an axis that is generally perpendicular to the plane defined by the user's face.

Alternatively or in addition, the pair of spectacles may have a weight of less than 200 grams.

More specifically, the pair of spectacles may have a weight of less than 100 grams.

Further embodiments of the second aspect of the present invention may comprise one or more features of the first aspect of the present invention.

According to a third aspect of the present invention there is provided a kit of parts comprising a Magnetic Resonance Imaging (MRI) scanner and optical apparatus according to the first aspect of the present invention, the optical apparatus being configured for use by a subject of the MRI scanner.

Embodiments of the third aspect of the present invention may comprise one or more features of the first and second aspects of the present invention.

According to a fourth aspect of the present invention there is provided a kit of parts comprising a Positron Emission Tomography (PET) scanner and optical apparatus according to the first aspect of the present invention, the optical apparatus being configured for use by a subject of the PET scanner.

Embodiments of the fourth aspect of the present invention may comprise one or more features of the first and second aspects of the present invention.

According to a further aspect of the present invention there is provided a method of treatment comprising the steps of: locating an optical device near an eye of a user; and the user looking through the optical device, the optical device being configured to reverse a field of view through the optical device laterally with respect to the user's eyes.

Embodiments of the further aspect of the present invention may comprise one or more features of the first to fourth aspects of the present invention.

### BRIEF DESCRIPTION OF DRAWINGS

Further features and advantages of the present invention will become apparent from the following specific description, which is given by way of example only and with reference to the accompanying drawings.

FIG. 1 is a perspective view of a pair of spectacles according to an embodiment of the present invention.

FIGS. 2a and 2b are perspective schematic views of a pair of spectacles according to alternative embodiments of the present invention.

FIGS. 3a, 3b and 3c are schematic side views of different prisms used in the present invention.

FIGS. 4a to 4d are schematic plan views of optical devices used in the present invention.

FIGS. 5a and 5b are schematic plan views of cylindrical lens arrangements used in the present invention.

FIG. 6a is a schematic side view of a cylindrical lens arrangement used in the present invention.

FIG. 6b is a schematic view of a Fresnel lens arrangement used in the present invention.

FIGS. 6c and 6d show alternative Fresnel lens arrangements.

FIG. 7 is a perspective view of a pair of spectacles according to a further embodiment of the present invention.

FIGS. 8a to 8h show embodiments of the present invention configured to be releasably attached to a pair spectacles worn by a user.

FIGS. 9a to 9c show embodiments of the present invention configured to be worn either way up by a user.

FIG. 10 shows an optical device according to the present invention mounted for rotation on a pair of spectacles.

FIGS. 11a to 11f show various embodiments of the invention having a prism and at least one lens.

### SPECIFIC DESCRIPTION

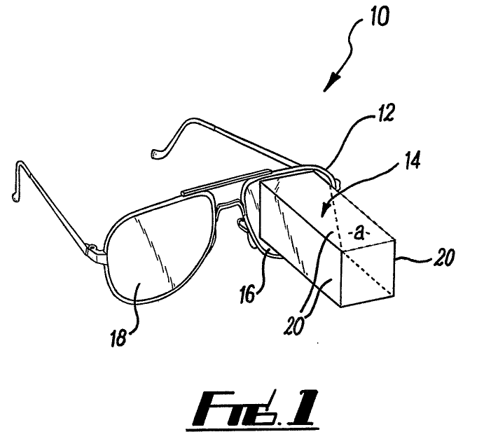

In FIG. 1 a pair of spectacles 10 according to an embodiment of the present invention is shown. The spectacle frame 12 constitutes a support, which supports a prism 14 in front of a first lens 16 of the spectacles. In FIG. 1, the area of the casing tube indicated by the letter ‘a’ indicates a portion of the prism that can be removed without compromising the operation of the prism according to the invention. The second lens 18 of the spectacles is opaque to substantially block the passage of light through the lens. In addition, a surface of a lens surrounding the prism 14 is opaque to restrict a field of view through the first lens 16. The field of view is further restricted by covering the top, bottom and side surfaces 20 of the prism 14 with an opaque material. The opaque material may have the form of a coating or a covering, e.g. of plastics. The pair of spectacles of FIG. 1 has a weight of about 90 grams.

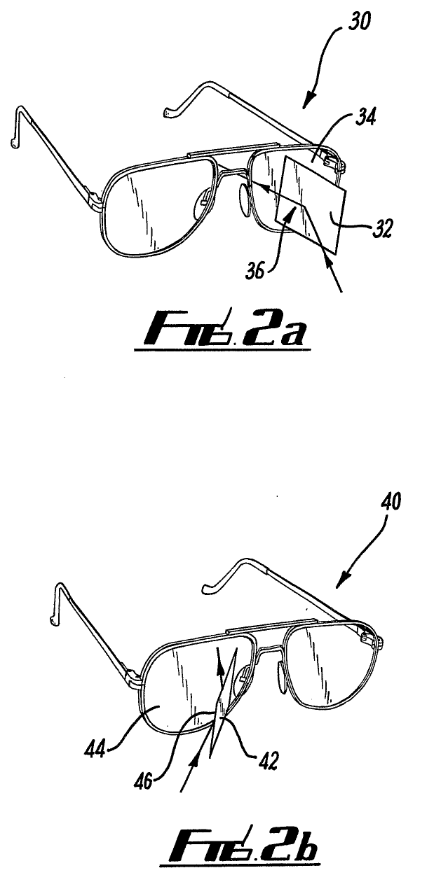

FIGS. 2a and 2b provide schematic views of pairs of spectacles 30, 40 according to alternative embodiments of the present invention. As shown in FIG. 2a a mirror 32 is attached in front of a first lens 34 of a pair of spectacles 30. A reflecting surface 36 (which constitutes a reflecting plane) of the mirror 32 faces towards a nasal side of a wearer of the spectacles 30. An alternative arrangement is shown in FIG. 2b, in which a mirror 42 is attached in front of a second lens 44 of a pair of spectacles 40. A reflecting surface 46 of the mirror 42 faces towards a temporal side of a wearer of the spectacles 40. FIGS. 2a and 2b are both schematic in nature and do not show how the mirrors 32, 42 are attached to the spectacles. Nevertheless, each mirror 32, 42 may be attached by means of an attachment member formed of plastics or the like which extends from the spectacle frame to a side of the mirror opposing the reflecting surface 36, 46. Furthermore, the lens of the spectacles 30, 40 without the mirror 32, 42 is opaque in the same manner as described above with reference to the spectacles shown in FIG. 1.

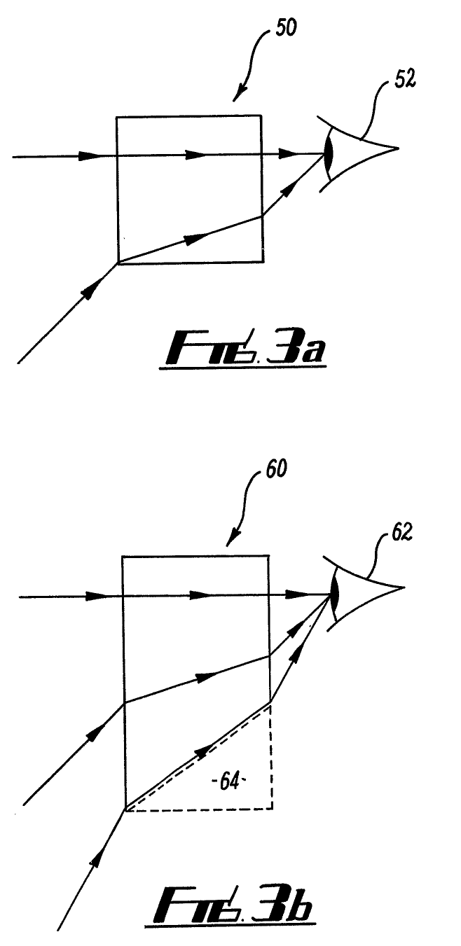

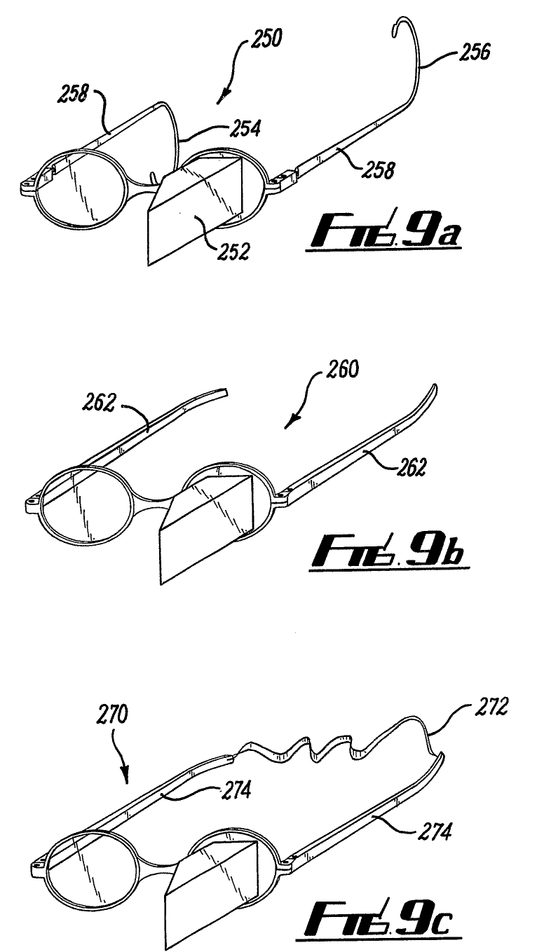

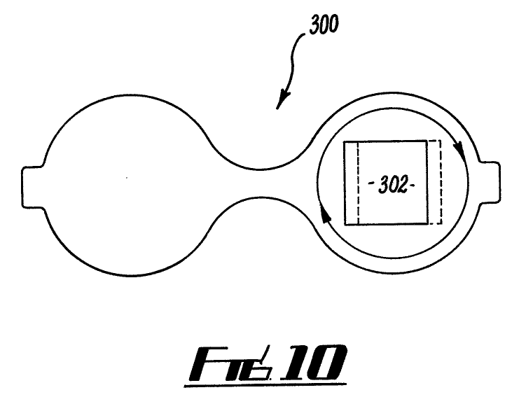

FIGS. 3a, 3b and 3c are schematic side views of alternative forms of prisms used in the embodiment shown in FIG. 1. In FIGS. 3a to 3c a field of view of a user's eye 52, 62, 66 is represented by the lines bearing arrows. In FIG. 3a, the prism 50 is comparatively shorter and thus provides for a limited vertical field of view. In FIG. 3b, the prism 60 is comparatively longer below eye level and thus provides for an increased vertical field of view. The dotted portion 64 of the prism can be removed as it falls outside a field of view of the user 62. In FIG. 3c, the prism 67 is comparatively longer both above and below eye level and thus provides for a further increased field of view. Thus, when the arrangement shown in FIG. 3c is used with the invertible embodiments shown in FIGS. 9a to 9c or with the rotatable embodiment shown in FIG. 10, the field of view extending below eye, which achieved by the arrangement of FIG. 3b, can be achieved by the arrangement of FIG. 3c irrespective of whether or not the prism 67 is upside down. The dotted portions 68 of the prism 67, which are towards the upper and lower extents of the prism and towards the user's eye, can be removed as they fall outside a field of view of the user 66.

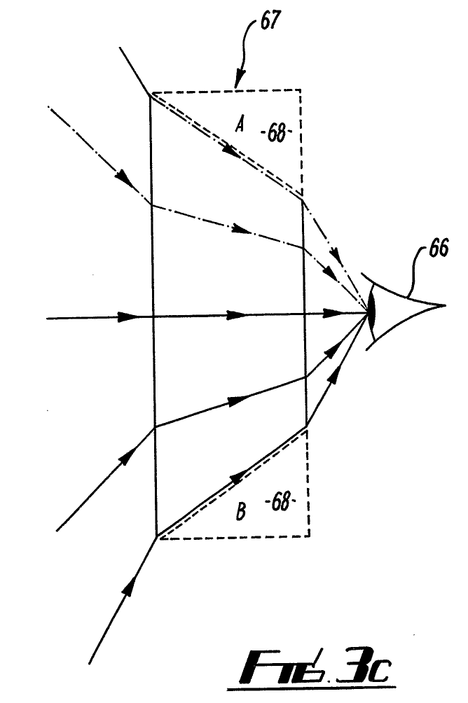

FIGS. 4a to 4d show schematic plan views of optical devices used in the embodiments of FIGS. 1, 2a and 2b. In FIGS. 4a to 4d lines bearing arrows illustrate rays of light passing through the optical devices and serve to illustrate the operation of the optical devices. FIG. 4a shows a dove prism 70. The dotted portion 72 of the prism 70 can be removed without affecting the operation of the prism in accordance with the invention. As can be seen from FIG. 4a, the incident light rays are reflected off the lower internal surface 74 (which constitutes a reflecting plane) of the prism 70. The effect of the reflection is to reverse an image viewed by a user through the prism. FIG. 4b shows a prism 80 like that of FIG. 4a, the sole difference being that, as indicated by the lines bearing arrows, a user views an image through the prism at an angle. Nevertheless, the effect of the reflection of the image by the prism 80 is the same as for FIG. 4a in that the image is reversed. In both FIGS. 4a and 4b the surfaces of the prisms 70, 80 are refracting as indicated by the change in direction of rays of light upon passing the respective surface. FIG. 4c shows another prism 90 having refracting surfaces 92. Here, normal incidence of light rays at the refracting surfaces 92 provides for unaffected passage of light through the surfaces of the prism 90. The prisms 70, 80, 90 of FIGS. 4a to 4c are used in the embodiment shown in FIG. 1. Turning now to FIG. 4d, a schematic plan view of a mirror 100 used in the embodiments of FIGS. 2a and 2b is shown. As with FIGS. 4a to 4c light rays are indicated by lines bearing arrows. As can be seen from FIG. 4d, the incident light rays are reflected off the lower internal surface 102 (which constitutes a reflecting plane) of the prism 100. The effect of the reflection is to reverse an image viewed by a user through the prism.

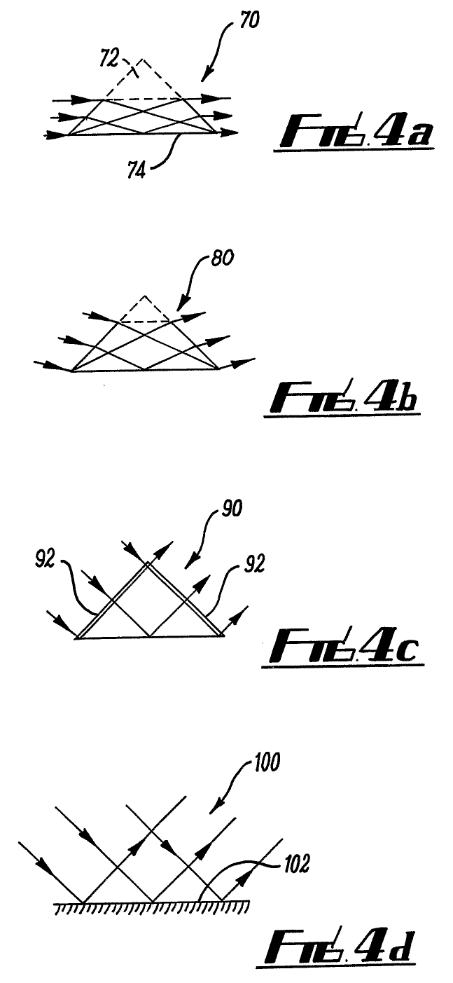

FIGS. 5a and 5b are schematic plan views of cylindrical lens arrangements. The cylindrical lens arrangements can form part of a pair of spectacles as shown in FIG. 1, 2a or 2b by substituting the prism of FIG. 1 for a cylindrical lens arrangement or by substituting the mirror of FIG. 2a or 2b for a cylindrical lens arrangement. In FIG. 5a the cylindrical lens arrangement 110 comprises first and second cylindrical lenses 112, 114, which are spaced apart from each other and oriented such that their planar surfaces face one another. As can be seen by the lines bearing arrows, which represent light rays, the cylindrical lenses reverse an image viewed by a user through the lenses. In view of the cylindrical form of the lenses, image reversal is in one direction, i.e. about a plane perpendicular to the planar surfaces of the cylindrical lenses. An alternative arrangement of cylindrical lenses is shown in FIG. 5b, in which the cylindrical lens 122 closer to an eye 124 of a user is smaller than the other cylindrical lens 126. As can be seen from the light rays, reducing the size of the lens 122 closer to the eye results in no loss of field of view.

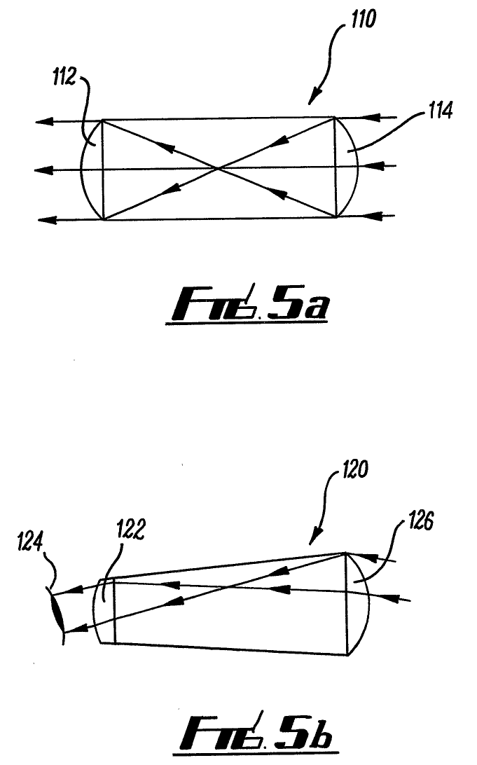

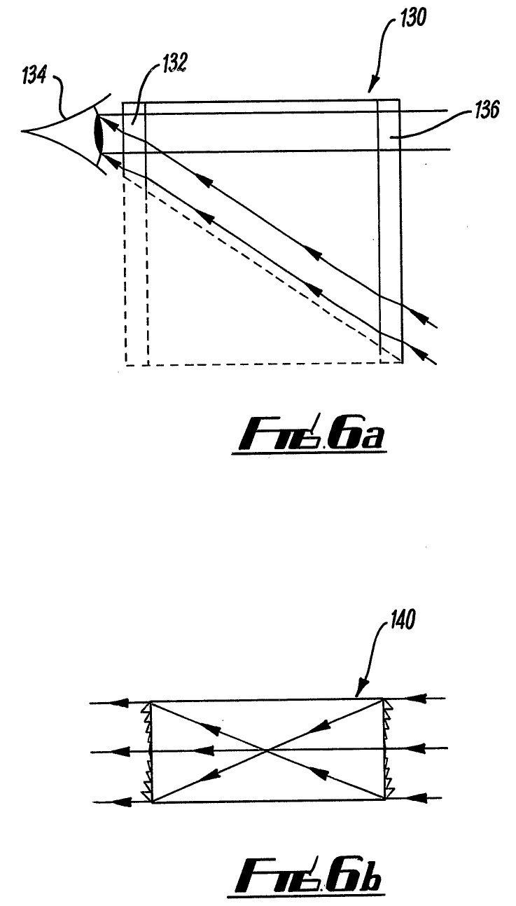

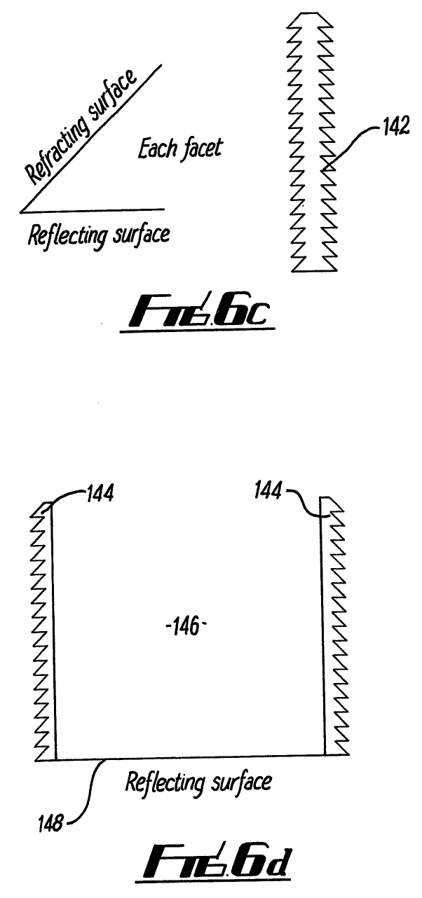

FIG. 6a shows a schematic side view of the cylindrical lens arrangements shown in FIGS. 5a and 5b. As can be seen from FIG. 6a, the smaller cylindrical lens 132 is located in front of an eye 134 of a user. As described above, the cylindrical lens arrangement 130 forms part of a pair of spectacles. As can be seen from FIG. 6a the vertical aperture of the eyepiece lens is increased. This allows for an increase in the tolerance of alignment of the arrangement in the vertical direction with respect to the eye's visual axis.

As shown in FIG. 6b an astigmatic Fresnel lens arrangement 140 may be used instead of the cylindrical lens arrangement. Use of such an arrangement can provide for reduction in weight.

One of two alternative Fresnel lens arrangements may be used instead of the cylindrical lens arrangement. In the first alternative arrangement shown in FIG. 6c, a Fresnel prism array 142 is provided in which each of the two surfaces of the array has a refracting angle. In the second alternative arrangement shown in FIG. 6d, two Fresnel prism arrays 144 separated by an air gap 146 are provided. A reflecting surface 148 is provided between the bases of the final prism pair of the arrays.

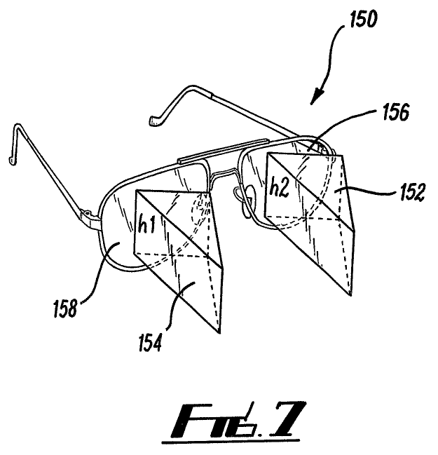

A further embodiment of the present invention is shown in FIG. 7. As can be seen from FIG. 7, a pair of spectacles 150 has a prism 152, 154 in front of each lens 156, 158 of the spectacles. Each prism 156, 158 is as described above with reference to FIGS. 3a to 4c. The presence of a prism 152, 154 in front of each lens 156, 158 provides for an image reversal for each eye of a wearer of the spectacles.

For example, a user with an arm amputation who is suffering from PLP wears one of the spectacles shown in FIGS. 1, 2a and 2b in the normal fashion and directs his gaze towards his remaining arm. e.g. his left arm. The image reversing properties of the optical device (i.e. prism, mirror or cylindrical lens arrangement) reverses the view of the left arm seen through the optical device laterally with respect to the user's eyes. The effect of this is that the viewed left arm appears to the user as his right arm, thereby tricking his brain into believing that the amputated right arm is present. As a result, it is understood that the user's brain undergoes re-mapping and this, in turn, reduces the PLP suffered by the user with an amputation.

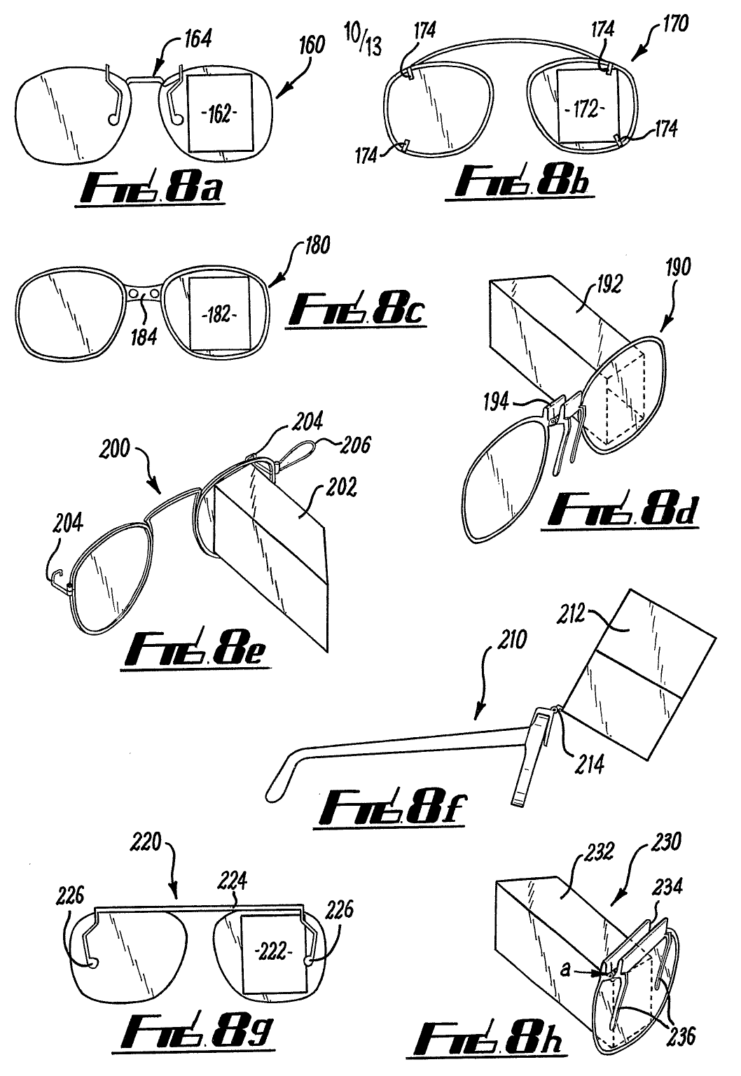

FIGS. 8a to 8h show different embodiments having optical devices according to the present invention. In each embodiment, the optical device (e.g. prism, mirror or cylindrical lens arrangement) is configured to reverse a field of view of a user through the optical device as described above and is configured to be releasably attached to a pair spectacles (which constitutes wearable apparatus) worn by a user. More specifically, FIG. 8a shows a pair of spectacles 160 lacking sides having an optical device 162 mounted over one lens and a spring clip 164 that allows the pair of spectacles to be clipped to a pair of spectacles (not shown) worn by a user. The spring clip 164, which may be formed from a metal or plastics material, and projects from the rear of the pair of spectacles 160. The spring force of the spring clip 164 may be predetermined to provide for a secure grip or for looser grip, whereby the pair of spectacles shown in FIG. 8a can be suspended from the worn pair of spectacles. The spring clip arrangement shown in FIG. 8a is also suitable for a uniocular arrangement in which the pair of spectacles consist of one lens only with occlusion of the fellow eye being provided by a separate occluding member. The arrangements shown in FIGS. 8a to 8g have a weight of about 25 grams.

FIG. 8b shows an alternative embodiment to that shown in FIG. 8a in which a pair of spectacles lacking sides 170 has an optical device 172 mounted over one lens and a number of un-sprung clips 174 spaced apart around the periphery of the frame of the pair of spectacles. In use, the un-sprung clips 174 are used to attach the pair of spectacles 170 to a pair of spectacles (not shown) worn by a user.

FIG. 8c shows a further embodiment in which a pair of spectacles lacking sides 180 has an optical device 182 mounted over one lens and a magnetic clip 184. In use, the magnetic clip 184 is used to attach the pair of spectacles 180 to a metal part, e.g. the frame, of a pair of spectacles (not shown) worn by a user.

FIG. 8d shows a rear perspective view of a further embodiment in which a pair of spectacles lacking sides 190 has an optical device 192 mounted over one lens and a spring clip 194 of a kind similar to that shown in FIG. 8a. The embodiment of FIG. 8d is clipped in much the same fashion as the embodiment of FIG. 8a to a pair of spectacles (not shown) worn by a user.

FIG. 8e shows a front perspective view of a further embodiment in which a pair of spectacles lacking sides 200 has an optical device 202 and an un-sprung clip 204 at each side of the pair of spectacles. The clips 204 are used to attach the pair of spectacles 200 to a pair of spectacles (not shown) worn by a user. A handle 206 is provided at one side of the pair of spectacles 206. Such a handle 206 can form part of any one of the embodiments shown in FIGS. 8a to 8h.

FIG. 8f shows a side view of a pair of spectacles having sides 210 to which a pair of spectacles 212 according to the embodiments shown in FIGS. 8a to 8e is clipped. The clipped on pair of spectacles 212 according to one of the embodiments is provided with a hinge 214, which allows for the clipped on pair of spectacles 212 to be rotated up out of the line of sight of the wearer. The clipped on pair of spectacles 212 may be modified by relocation of the hinge 214 to provide for rotation of the clipped on pair of spectacles sideways (or temporally of the wearer) out of the line of sight of the wearer. The hinge 214 can form part of a monocular spectacle arrangement in which rotation is either upwards or sideways.

FIG. 8g shows an embodiment 220 having an optical device 222 that is the same as the embodiment shown in FIG. 8a with the exception of the provision of gripping members 226 of the spring clip 224 towards the temporal sides of the pair of spectacles. The embodiment of FIG. 8d can be modified in the same fashion.

FIG. 8h shows a rear perspective view of a monocular arrangement 230 having an optical device 232 and a spring clip 234. The gripping members 236 of the spring clip 234 are spaced apart such that they are located towards each side of the arrangement.

Where a spring clip is present in the embodiments of FIGS. 8a to 8h the spring may have the form of a leaf spring, a helical spring or the like.

FIGS. 9a to 9c show pairs of spectacles according to the invention having an optical device mounted over one lens. The spectacles of FIGS. 9a to 9c are configured to be worn either way up by a user. The capability to wear the spectacles either way up allows the optical device to be used with either the left or the right eye of the user.

FIG. 9a shows a pair of spectacles 250 having an optical device 252 mounted over one lens. The distal portions 254, 256 of the sides 258 of the pair of spectacles 250 are each shaped to fit around the ear of a wearer of the pair of spectacles. The first 254 and second 256 distal portions extend in substantially opposite directions such that in use one of the first and second distal portions 254, 256 engage with an ear. For example, when the pair of spectacles 250 is worn a first way up (as shown in FIG. 9a) the first distal portion 254 engages with the wearer's ear. When the pair of spectacles is worn upside down the second distal portion 256 engages with the wearer's ear.

FIG. 9b shows a pair of spectacles 260 which is the same as the pair of spectacles shown in FIG. 9a with the exception that the spectacles have straight sides 262. In use, each of the straight sides 262 rests on a respective ear of a wearer of the pair of spectacles irrespective of whichever way up the pair of spectacles is worn.

FIG. 9c shows a pair of spectacles 270 which is the same as the pair of spectacles of FIG. 9b with the further feature of a strap 272 attached to the distal portions of the sides 274 of the pair of spectacles. In use, the strap is fitted around the head of the wearer of the pair of spectacles 270 to help keep the pair of spectacles in place.

FIG. 10 shows a pair of spectacles 300 having an optical device 302 mounted over one lens. The other lens is occluded. The optical device is mounted over the lens for rotation of the optical device in relation to the pair of spectacles about the coronal plane. The arrangement of FIG. 10 is used with the pairs of reversible spectacles shown in FIGS. 9a to 9c as follows. The pair of spectacles 300 is worn a first way up such that the optical device is positioned in front of the wearer's right eye. When the pair of spectacles is turned upside down on the head of the wearer the optical device 302 is positioned in front of the left eye of the wearer. Depending on the configuration of the optics in the optical device 302, positioning of the optical device in front of the wearer's left eye instead of his right eye can result in the field of view through the optical device being directed such that the pair of spectacles cannot be used properly. Rotation of the optical device 302 in relation to the pair of spectacles allows the wearer to redirect the field of view for proper use of the pair of spectacles. Furthermore, rotation of the optical device 302 through substantially 180 degrees provides for a change between two centration distances, i.e. spacings between the eyes of different users. In FIG. 10 the solid lines show the optical device at a first centration distance and the dotted lines show the optical device at a second centration distance. Where the optical device is an inherently decentered device, such as a Dove prism or the like, a change in centration distance can be achieved even where such an optical device is located centrally on the lens.

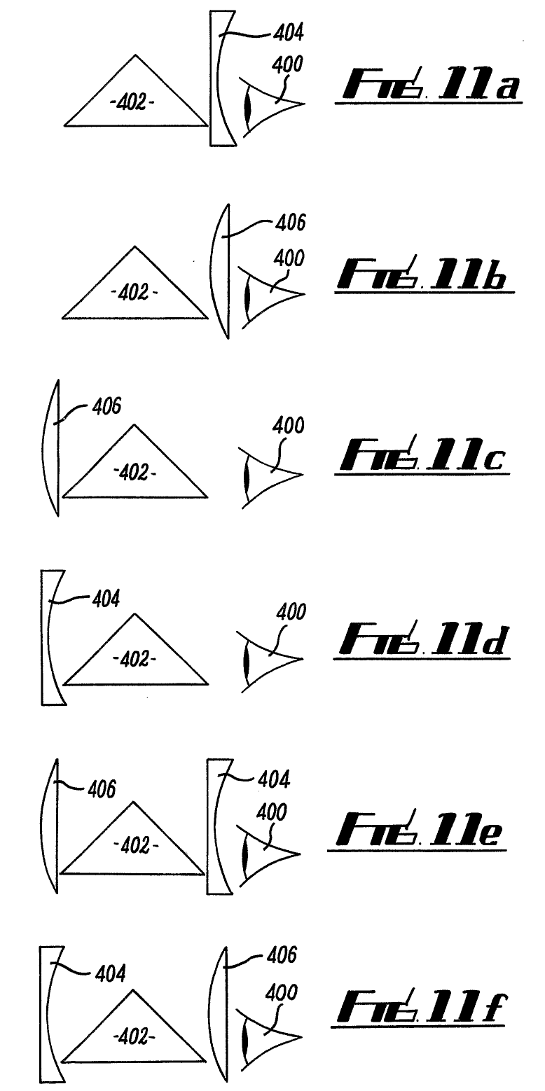

Various embodiments of the invention having a prism and at least one lens are shown in FIGS. 11a to 11f. In each of FIGS. 11a to 11f the eye 400 is shown in relation to each embodiment. Each of the embodiments comprises a prism 402, which functions as described above.

FIGS. 11a and 11b show embodiments in which a lens is provided between the eye 400 and the prism 402. The embodiment of FIG. 11a has a negatively powered lens 404, which provides for minification, and the embodiment of FIG. 11b has a positively powered lens 406, which provides for magnification.

FIGS. 11c and 11d show embodiments in which a lens is provided on the other side of the prism 402 from the eye 400. The embodiment of FIG. 11c has a positively powered lens 406, which provides for magnification, and the embodiment of FIG. 11d has a negatively powered lens 404, which provides for magnification.

For the embodiments of FIG. 11a and 11d image quality depends on the focusing ability of the user's eye to overcome or at least reduce defocusing caused by the lens. The disposition of the lenses of the embodiments of FIGS. 11a to 11d in relation to the eye 400 and the prism 402 and the optical characteristics and dimensions of the lenses determine factors, such as extent of magnification, extent of minification, extent of field of view and the distance of objects that can be seen clearly. The disposition, optical characteristics and dimensions can be determined to meet specific requirements in accordance with well known optical design practice. The disposition of the lens further away from the eye in FIGS. 11c and 11d compared with FIGS. 11a and 11b has an effect, in accordance with well known optical design practice, on the extent of magnification or minification. In forms of the embodiments, an astigmatic lens is used to provide meridional distortion of a viewed object.

FIGS. 11e and 11f show embodiments having one positively powered lens 406 and one negatively powered lens 404 disposed on opposing sides of the prism 402.

The embodiment of FIG. 11e will be recognised as a Galilean configuration in which the negatively powered lens 404 is disposed between the prism 402 and the eye 400; such an embodiment is more readily configured to provide for magnification than minification. Minification is possible where the focal length of the negatively powered lens 404 is greater than the focal length of the positively powered lens 406. The embodiment of FIG. 11f will be recognised as a reverse Galilean configuration in which the positively powered lens 406 is disposed between the prism 402 and the eye 400; such an embodiment is more readily configured for minification than magnification. The magnification or minification is determined by the ratio of the focal lengths of the lenses.

The embodiments of FIGS. 11e and 11f are configured such that the distance between the lenses is the difference in their focal lengths; this provides for ease of viewing of objects further away from the apparatus than parts of the user's body. Alternatively, the embodiments are configured such that distance between the lenses is greater than the difference in their focal lengths; this provides for ease of viewing of parts of the user's body. In forms of the embodiments, the lenses are astigmatic to provide for meridional magnification differences. To provide for all meridians to be optimal focus the astigmatic axes of the lenses are parallel and the differences of the focal lengths in each meridian are the same. As with the embodiments of FIGS. 11a to 11d, the disposition, optical characteristics and dimensions of the lenses of the embodiments of FIGS. 11e and 11f can be determined to meet specific requirements in accordance with well known optical design practice.

In un-illustrated forms of the above described embodiments the optical apparatus has a spirit level of conventional design and operation, which is operative to indicate when the optical apparatus is level with respect to the ground. In addition, in un-illustrated forms of optical apparatus in which the optical device is rotatable, such as is shown in FIG. 10, a graduated scale is provided on the optical apparatus and a moving indicator, such as a mark, is provided on the optical device. As the optical device rotates, the mark moves in relation to the graduated scale to indicate and extent to which the optical device is rotated. Thus, an orientation of the optical apparatus with respect to a bodily plane may be determined.

1. Optical apparatus configured to be worn on the head of a user of the optical apparatus comprising: a support configured for location and use of the optical apparatus near an eye of the user of the optical apparatus; and solely one optical device supported by the support such that, in use, the optical device is within a visual field of one eye of the user, the optical device being configured to reverse a field of view of the user's eye through the optical device laterally with respect to the user's eyes, the optical device comprising an optical component that defines a plane about which the field of view is reflected, the optical device being configured such that the plane defined by the optical component is substantially in the user's sagittal plane.

2-78. (canceled)

79. Optical apparatus according to claim 1, in which the optical apparatus is configured such that the plane faces towards one of a temporal side and a nasal side of the user's visual field.

80. Optical apparatus according to claim 1, in which the optical device comprises a mirror.

81. Optical apparatus according to claim 1, in which the optical device comprises at least one prism.

82. Optical apparatus according to claim 81, in which the prism is configured to provide for total internal reflection.

83. Optical apparatus according to claim 81, in which the prism is truncated in form.

84. Optical apparatus according to claim 1, in which the optical device comprises at least one Fresnel-type prism.

85. Optical apparatus according to claim 1, in which the optical device comprises a prism and a pair of lenses.

86. Optical apparatus according to claim 85, in which a distance between the lenses is greater than a difference of the focal lengths of the lenses, whereby the optical apparatus is configured for viewing parts of the user's body.

87. Optical apparatus according to claim 1, in which the optical device comprises a pair of astigmatic lenses.

88. Optical apparatus according to claim 1, in which the support is configured for attachment of the optical apparatus to wearable apparatus configured to be worn on the head of the user.

89. Optical apparatus according to claim 88, in which the support is configured for releasable attachment of the optical apparatus to the wearable apparatus.

90. Optical apparatus according to claim 89, in which the support comprises a clip configured to engage the wearable apparatus and the support comprises a biasing device that is operative to bias the clip and provide for tight engagement of the clip and the wearable apparatus.

91. Optical apparatus according to claim 1 further comprising a member configured to obstruct a field of view of the eye of the user other than the eye with which the optical device is operable.

92. Optical apparatus according to claim 91, in which the member is one of opaque and translucent.

93. A pair of spectacles comprising optical apparatus according to claim 1.

94. A pair of spectacles according to claim 93, in which the pair of spectacles comprises a first lens apparatus, which comprises the optical apparatus, and a second lens apparatus configured to obstruct a field of view of one of the user's eyes through the second lens apparatus.

95. A pair of spectacles according to claim 93, in which the pair of spectacles is configured such that they are wearable one way up or wearable a second way up when turned upside down.

96. A pair of spectacles according to claim 95, in which the first and second lens apparatus are spaced apart from each other and connected by a bridge, the bridge having at least one resilient member provided on the bridge such that when the spectacles are worn either way up the at least one resilient member is interposed between the nose of the user and the rest of the bridge.

97. A pair of spectacles according to claim 93, in which the optical device is rotatable in relation to the pair of spectacles and within a plane that is parallel to a plane generally defined by the user's face when the pair of spectacle is in use, whereby the field of view is movable laterally with respect to the user's eyes.
